(19) United States
(12) Patent Application Publication
(10) Pub. No.: US 2018/0199543 A1
(43) Pub. Date: Jul. 19, 2018

(54) Methods For Cleaning Waste Oil From Birds

(71) Applicants: Brighton Risch, Malvern, PA (US); Simran Sahoo, West Chester, PA (US); Aditya Bhosale, Malvern, PA (US); Ananya Singhal, West Chester, PA (US); Aditi Purohit, Chester Springs, PA (US); Amanda Mengle, Exton, PA (US); Lasya Tirumamidi, West Chester, PA (US)

(72) Inventors: Brighton Risch, Malvern, PA (US); Simran Sahoo, West Chester, PA (US); Aditya Bhosale, Malvern, PA (US); Ananya Singhal, West Chester, PA (US); Aditi Purohit, Chester Springs, PA (US); Amanda Mengle, Exton, PA (US); Lasya Tirumamidi, West Chester, PA (US)

(21) Appl. No.: 15/869,123

(22) Filed: Jan. 12, 2018

Related U.S. Application Data
(60) Provisional application No. 62/446,022, filed on Jan. 13, 2017.

(51) Int. Cl. A01K 13/00; B01D 15/00; B01J 20/26

(52) U.S. Cl. CPC A01K 13/001; B01D 15/00; C08L 33/08; A01K 2227/30; B01J 20/261

(57) ABSTRACT

A method of removing waste oil from an animal includes the steps of contacting the animal having waste oil with a solid oil-absorbent material for a sufficient duration for the oil-absorbent material to absorb at least a portion of the waste oil and removing the oil-absorbent material with the absorbed waste oil from the animal.

### CROSS REFERENCE TO RELATED APPLICATIONS

This application claims the benefit of U.S. Provisional Application No. 62/446,022, filed Jan. 13, 2017, the entirety of which is incorporated herein for any and all purposes.

### TECHNICAL FIELD

The present disclosure generally relates to methods for removing oil, and specifically to methods for removing waste oil from an animal.

### BACKGROUND

Cleaning up birds and other animals after an oil spill or similar incident has changed little in the past decades. The method involves washing the animal in a bath comprising water and dish-soap (most notably, Dawn dish soap). The method is time consuming, costly, and potentially harmful to the animal. In addition, this method typically uses a relatively large volume of water.

### SUMMARY

Disclosed are methods of removing waste oil from an animal. A method for removing waste oil from an animal includes the steps of contacting the animal having waste oil with a solid oil-absorbent material for a sufficient duration for the oil-absorbent material to absorb at least a portion of the waste oil and removing the oil-absorbent material with the absorbed waste oil from the animal.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In the drawings:

FIG. 1 is a table of experimental and sample cost calculations according to an embodiment; and

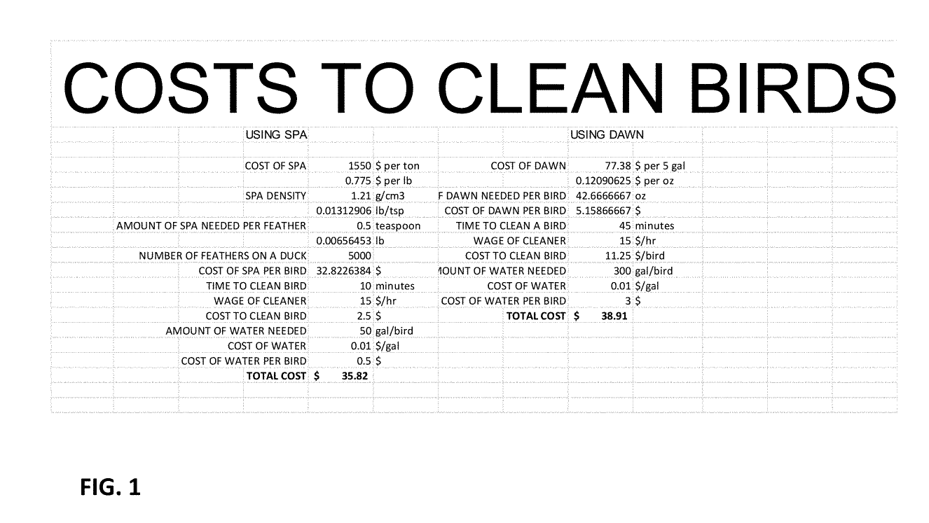

FIG. 2 is a graph depicting the approximate percentage of absorption based on various embodiments.

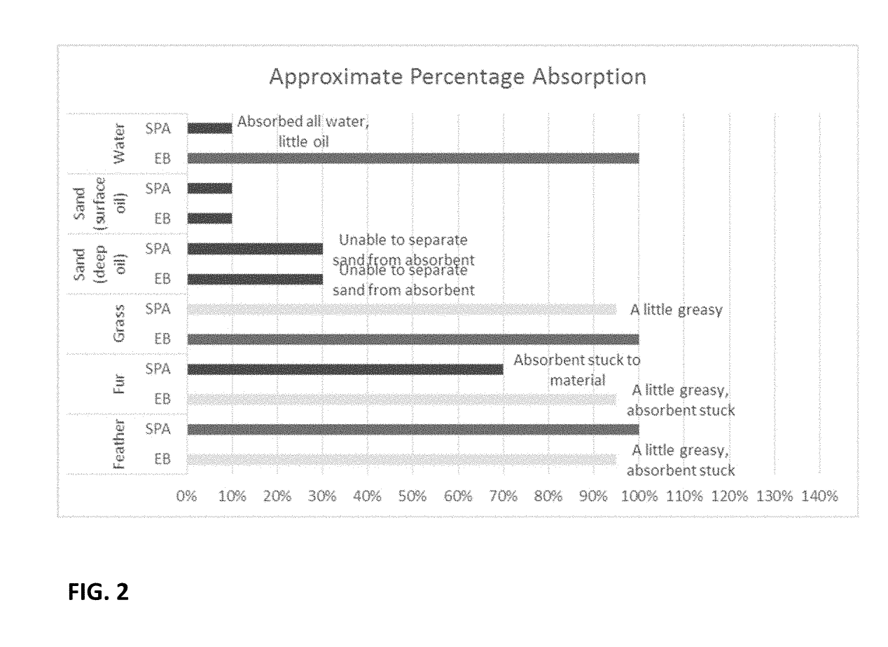

### DETAILED DESCRIPTION OF ILLUSTRATIVE EMBODIMENTS

The present invention is a novel method of cleaning oily animals using oil-absorbent materials. This method is cheaper, more effective, cleaner, and potentially less risky for the animal than prior art methods using only dish-soap solutions. In addition, the method uses significantly less water than those prior art methods.

The method involves removing waste hydrocarbon materials, most commonly waste oil, using an oil-absorbent material. In a preferred embodiment, the oil-absorbent material is a bonding polymer. One bonding polymer useful in the present method is sodium polyacrylate (SPA), a highly absorbent compound typically used in diapers or “insta-snow.” The bonding polymers have the properties of rendering the liquid waste oil into a jelly-like solid that is the waste oil/bonding polymer material. The waste oil/bonding polymer material can then be removed from the animal because the waste oil is then bonded with the polymer rather than the animal.

Another preferable oil-absorbent material to use either instead of SPA, or in combination with it, is a compound that absorbs only hydrocarbons. These hydrocarbon-only absorbing compounds have the benefit of not absorbing water like SPA, but have the drawbacks of not being as absorbent as SPA. The choice as to which material or combination of materials to use may be best dictated by the type of environment that requires remediation. An example of a suitable hydrocarbon-only absorbing compound is sold under the brand name Enviro-bond 403.

The novel method for cleanup involves the following:
a) applying the oil-absorbent material to the animal's body in sufficient quantity to remove the oil. For example, Enviro-bond 403 reports a 1:1 absorbency with crude oil (which may be expected in an oil spill). Thus, an animal coated with a pound of oil may be cleaned with approximately one pound of the oil-absorbent material. In experiments, half a teaspoon of SPA removed a teaspoon of oil from feathers.
b) Removing the oil-absorbent material now augmented with the captured oil with rags, brushes, hands, or any other suitable instruments and materials.
c) Disposing of the oil/oil-absorbent material waste as appropriate.
d) Cleaning any remaining oil residue by way of bathing the animal in a solution of water and dishwashing detergent according to the prior art.

As an extension to the novel method, the oil-absorbent material as described above may be combined with a sorbent substrate or matrix, such as a pad, rag, or other item prior to use in the method of cleaning oil from the animal. The material ideally would be hydrophobic and absorb only hydrocarbons; there are many blown-melt polypropylene pads publicly available that would suit this purpose. Furthermore, a sorbent substrate or matrix with the oil-absorbent material already embedded within it, as described in U.S. Pat. No. 5,547,313 might be used to maximum effect. To be clear, the invention is the use of such oil-absorbent materials, e.g., polymers, hydrophobic sorbents, and combination products for the cleaning of animals, and not the underlying products themselves.

This is a long-felt unmet need. The prior art has not heretofore thought to use these materials this way, and neither the documentation of the products nor Internet sites that discuss cleaning animals discuss using them in this way. Moreover, those in this field, when informed of the methods disclosed herein, expressed surprise and skepticism.

The advantages to the methods disclosed herein are many over the prior art methods for cleaning oil from animals. The methods disclosed herein will be easier to perform, and be more efficient for the workers. Also, the present method will use significantly less water. SPA is an easier and quicker way for both the bird and bird washer. SPA is not toxic if touched. At the same time, you can use fewer people than is required the traditional method. Additionally, time is saved. Using the prior art dish soap method, the time to cleanse an animal is significantly longer. The methods disclosed herein also use less material to cleanse the animal; for example, while the traditional method requires 12.5 bottles of dish soap per bird, the described inventive method may use about 50 cups of SPA per bird.

While systems and methods have been described in connection with the various embodiments of the various figures, it will be appreciated by those skilled in the art that changes could be made to the embodiments without departing from the broad inventive concept thereof. It is understood, therefore, that this disclosure is not limited to the particular embodiments disclosed, and it is intended to cover modifications within the spirit and scope of the present disclosure as defined by the claims.

What is claimed:

1. A method of removing waste oil from an animal comprising the steps of:
contacting the animal having waste oil with a solid oil-absorbent material for a sufficient duration for the oil-absorbent material to absorb at least a portion of the waste oil; and
removing the oil-absorbent material with the absorbed waste oil from the animal.

2. The method of claim 1, wherein before the contacting step, the oil-absorbent material is administered to a substrate, and where the contacting step includes contacting the animal with a substrate having the oil-absorbent material.

3. The method of claim 1, wherein the waste oil comprises crude oil.

4. The method of claim 3, wherein the oil-absorbent material comprises sodium polyacrylate.

5. The method of claim 3, wherein the oil-absorbent material comprises a polymer configured to chemically bond with a hydro-carbon.

6. The method of claim 5, wherein the polymer comprises Enviro-bond 403.
